(19) United States
(12) Patent Application Publication
(10) Pub. No.: US 2024/0284225 A1
(43) Pub. Date: Aug. 22, 2024

(54) METHOD AND APPARATUS OF CONFIGURING AND SIGNALING MULTIPLE MEASUREMENT REPORT TRIGGERING EVENTS IN COMMUNICATION SYSTEM

(71) Applicant: Samsung Electronics Co., Ltd., Suwon-si (KR)

(72) Inventors: Weiping SUN, Suwon-si (KR); Jaehyuk JANG, Suwon-si (KR); Sangyeob JUNG, Suwon-si (KR)

(21) Appl. No.: 18/444,547

(22) Filed: Feb. 16, 2024

(30) Foreign Application Priority Data
Feb. 16, 2023 (KR) 10-2023-0020926

(51) Int. Cl. H04W 24/10

(52) U.S. Cl. CPC H04W 24/10

(57) ABSTRACT

The disclosure relates to a 5G or 6G communication system for supporting a higher data transmission rate. A method performed by a user equipment (UE) in a communication system including: receiving measurement configuration information including information on a predefined event, wherein the predefined event corresponds to a first event and a second event; identifying, based on the information on the predefined event, whether an entering condition for the predefined event is satisfied, wherein the entering condition for the predefined event is satisfied in case that both an entering condition for the first event and an entering condition for the second event are fulfilled; and transmitting measurement report based on the identification.

### CROSS REFERENCE TO RELATED APPLICATION

The present application claims priority to Korean Patent Application No. 10-2023-0020926, filed on Feb. 16, 2023, the entire contents of which is incorporated herein for all purposes by this reference.

### BACKGROUND

### 1. Field

The present disclosure may relate to terminal and base station operations in a wireless communication system.

### 2. Description of the Related Art

5^{th} generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

The disclosure is to provide an apparatus and method that can effectively provide services in a communication system.

The technical objects to be achieved by various embodiments of the disclosure are not limited to the technical objects mentioned above, and other technical objects not mentioned may be considered by those skilled in the art from various embodiments of the disclosure to be described below.

According to an embodiment, a method performed by a user equipment (UE) in a communication system is provided.

According to an embodiment, the method includes receiving measurement configuration information including information on a predefined event, wherein the predefined event corresponds to a first event and a second event; identifying, based on the information on the predefined event, whether an entering condition for the predefined event is satisfied, wherein the entering condition for the predefined event is satisfied in case that both an entering condition for the first event and an entering condition for the second event are fulfilled; and transmitting measurement report based on the identification.

According to an embodiment, the first event is associated with a measurement of a cell and the second event is associated with altitude of the UE.

According to an embodiment, the first event is one of event A3, event A4, or event A5.

According to an embodiment, the second event is one of event H1 or event H2.

According to an embodiment, the method further includes identifying a leaving condition for the predefined event is satisfied in case that both a leaving condition for the first event and a leaving condition for the second event are fulfilled.

According to an embodiment, the information on the predefined event includes first parameters for the first event and second parameters for the second event.

According to an embodiment, a user equipment (UE) in a communication system is provided.

According to an embodiment, the UE includes a transceiver; and a processor coupled with the transceiver and configured to: receive measurement configuration information including information on a predefined event, wherein the predefined event corresponds to a first event and a second event; identify, based on the information on the predefined event, whether an entering condition for the predefined event is satisfied, wherein the entering condition for the predefined event is satisfied in case that both an entering condition for the first event and an entering condition for the second event are fulfilled; and transmit measurement report based on the identification.

According to an embodiment, the first event is associated with a measurement of a cell and the second event is associated with altitude of the UE.

According to an embodiment, the first event is one of event A3, event A4, or event A5.

According to an embodiment, the second event is one of event H1 or event H2.

According to an embodiment, the processor is further configured to identify a leaving condition for the predefined event is satisfied in case that both the leaving condition for the first event and the leaving condition for the second event are fulfilled.

According to an embodiment, the information on the predefined event includes first parameters for the first event and second parameters for the second event.

According to an embodiment, a method performed by a base station in a communication system is provided.

According to an embodiment, the method includes: transmitting measurement configuration information including information on a predefined event, wherein the predefined event corresponds to a first event and a second event; and receiving measurement report associated with the measurement configuration information.

According to an embodiment, an entering condition for the predefined event is satisfied in case that both an entering condition for the first event and an entering condition for the second event are fulfilled.

According to an embodiment, the first event is associated with a measurement of a cell and the second event is associated with altitude of a user equipment (UE).

According to an embodiment, the first event is one of event A3, event A4, or event A5.

According to an embodiment, the second event is one of event H1 or event H2.

According to an embodiment, a leaving condition for the predefined event is satisfied in case that both a leaving condition for the first event and a leaving condition for the second event are fulfilled.

According to an embodiment, the information on the predefined event includes first parameters for the first event and second parameters for the second event.

According to an embodiment, a base station in a communication system is provided.

According to an embodiment, the base station includes: a transceiver; and a processor coupled with the transceiver and configured to: transmit measurement configuration information including information on a predefined event, wherein the predefined event corresponds to a first event and a second event; and receive measurement report associated with the measurement configuration information.

According to an embodiment, an entering condition for the predefined event is satisfied in case that both an entering condition for the first event and an entering condition for the second event are fulfilled.

According to an embodiment, the first event is associated with a measurement of a cell and the second event is associated with altitude of a user equipment (UE).

According to an embodiment, the first event is one of event A3, event A4, or event A5.

According to an embodiment, the second event is one of event H1 or event H2.

According to an embodiment, a leaving condition for the predefined event is satisfied in case that both a leaving condition for the first event and a leaving condition for the second event are fulfilled.

According to an embodiment, wherein the information on the predefined event includes first parameters for the first event and second parameters for the second event.

The above-described various embodiments of the disclosure are merely some of the preferred embodiments of the disclosure, and various embodiments reflecting the technical features of the disclosure may be derived and understood by those skilled in the art based on the following detailed description of the disclosure.

The disclosure may provide an apparatus and method that can effectively provide services in a communication system.

The effects that can be achieved through the disclosure are not limited to the effects mentioned in the various embodiments, and other effects not mentioned will be clearly understood by those skilled in the art from the description below.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a structure of an NR system according to an embodiment of the disclosure;

FIG. 2 illustrates a wireless protocol structure in an NR system according to an embodiment of the disclosure;

FIG. 3 illustrates an example of a procedure in which a UAV terminal transmits a measurement report to a base station in a next-generation mobile communication system according to an embodiment of the disclosure;

FIG. 4 illustrates an example of a relationship between MO, measId, and reportConfig including one event configuration information according to an embodiment of the disclosure;

FIG. 5 illustrates an example of a relationship between measId, MO, and reportConfig including a plurality of event configuration information according to an embodiment of the disclosure;

FIG. 6 illustrates an example of a structure in which one measId has an association relationship with a plurality of reportConfig according to an embodiment of the disclosure;

FIG. 7 illustrates an example of a structure in which one measId may have an association relationship with an event indicated in a plurality of reportConfig according to an embodiment of the disclosure;

FIG. 8 illustrates an example of a procedure in which a UAV terminal transmits a measurement report to a base station in a next-generation mobile communication system according to an embodiment of the disclosure;

FIG. 9 illustrates a structure of a terminal according to an embodiment of the disclosure; and

FIG. 10 illustrates a structure of a base station according to an embodiment of the disclosure.

### DETAILED DESCRIPTION

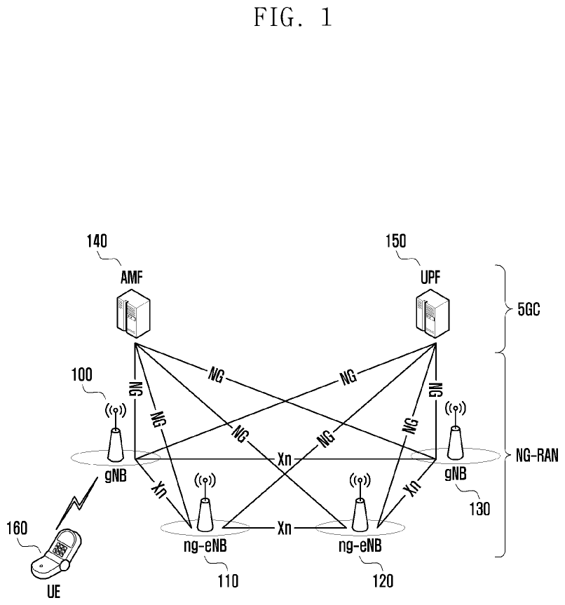

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, preferred embodiments of the disclosure will be described with reference to accompanying drawings. Here, in the accompanying drawings, the same or like elements are designated by the same or like reference numerals as much as possible. Further, a detailed description of known functions or structure that may obscure the subject matter of the disclosure may be omitted.

In describing the embodiments of the disclosure, descriptions of technical contents that are well known in the technical field to which the disclosure belongs and are not directly related to the disclosure will be omitted. By omitting the unnecessary description, the gist of the disclosure may be more clearly conveyed without obscuring the subject matter.

For the same reason, in the accompanying drawings, some elements may be exaggerated, omitted, or schematically illustrated. Further, the size of each element does not completely reflect the actual size. In each drawing, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The embodiments are provided only to completely disclose the disclosure and inform those skilled in the art of the scope of the disclosure, and the disclosure is defined only by the scope of the appended claims. Throughout the specification, the same or like reference numerals designate the same or like elements.

Here, it will be understood that combinations of blocks in flowcharts or process flow diagrams may be performed by computer program instructions. Because these computer program instructions may be loaded into a processor of a general purpose computer, a special purpose computer, or another programmable data processing apparatus, the instructions, which are performed by a processor of a computer or another programmable data processing apparatus, create units for performing functions described in the flowchart block(s). The computer program instructions may be stored in a computer-usable or computer-readable memory capable of directing a computer or another programmable data processing apparatus to implement a function in a particular manner, and thus the instructions stored in the computer-usable or computer-readable memory may also be capable of producing manufacturing items containing instruction units for performing the functions described in the flowchart block(s). The computer program instructions may also be loaded into a computer or another programmable data processing apparatus, and thus, instructions for operating the computer or the other programmable data processing apparatus by generating a computer-executed process when a series of operations are performed in the computer or the other programmable data processing apparatus may provide operations for performing the functions described in the flowchart block(s).

In addition, each block may represent a portion of a module, segment, or code that includes one or more executable instructions for executing specified logical function(s). It should also be noted that in some alternative implementations, functions mentioned in blocks may occur out of order. For example, two blocks illustrated successively may actually be executed substantially concurrently, or the blocks may sometimes be performed in a reverse order according to the corresponding function.

Here, the term “unit” used in the disclosure means a software component or hardware component such as field programmable gate array (FPGA) or application specific integrated circuit (ASIC), and performs a specific function. However, the term “unit” is not limited to software or hardware. The “unit” may be formed so as to be in an addressable storage medium, or may be formed so as to operate one or more processors. Thus, for example, the term “unit” may refer to components such as software components, object-oriented software components, class components, and task components, and may include processes, functions, attributes, procedures, subroutines, segments of program code, drivers, firmware, micro codes, circuits, data, a database, data structures, tables, arrays, or variables. A function provided by the components and “units” may be associated with the smaller number of components and “units,” or may be further divided into additional components and “units.” Furthermore, the components and “units” may be embodied to reproduce one or more CPUs in a device or security multimedia card.

Hereinafter, a base station is an entity that allocates resources to a terminal, and may be at least one of a Node B, a base station (BS), an eNode B (eNB), a gNode B (gNB), a wireless access unit, a base station controller, and a node on a network. A terminal may include a user equipment (UE), a mobile station (MS), a cellular phone, a smartphone, a computer, or a multimedia system capable of performing communication functions. In addition, an embodiment of the disclosure may be applied to other communication systems having a similar technical background or channel type as the embodiment of the disclosure described below. In addition, an embodiment of the disclosure may be applied to other communication systems through some modifications without significantly departing from the scope of the disclosure at the discretion of those skilled in the art.

For example, the technologies may include 5th generation mobile communication technologies (5G, new radio (NR)) developed beyond LTE-A, and in the following description, the 5G may be the concept that covers the exiting LTE, LTE-A, or other similar services. In addition, based on determinations by those skilled in the art, the disclosure may also be applied to other communication systems through some modifications without significantly departing from the scope of the disclosure.

In the following description, terms for identifying access nodes, terms with reference to network entities or network functions (NFs), terms with reference to messages, terms with reference to interfaces between network entities, terms with reference to various identification information, and the like are illustratively used for the sake of convenience. Therefore, the disclosure is not limited by the terms as used below, and other terms with reference to subjects having equivalent technical meanings may be used.

In the following description, the disclosure will be described using terms and names defined in the 3rd generation partnership project (3GPP) long term evolution (LTE) standards and/or 3GPP new radio (NR) standards for the convenience of description. However, the disclosure is not limited by these terms and names, and may be applied in the same way to systems that conform other standards.

FIG. 1 illustrates a structure of an NR system according to an embodiment of the disclosure.

With reference to FIG. 1, a wireless communication system may be constituted to include several base stations (e.g., gNB 100, ng-eNB 110, ng-eNB 120, and gNB 130), an access and mobility management function (AMF) 140, and a user plane function (UPF) 150. It is apparent that a wireless communication system is not limited to the structure illustrated in FIG. 1, and may include more or fewer components.

According to an embodiment of the disclosure, a user terminal (hereinafter, referred to as UE or a terminal) 160 may access an external network through the base stations 100, 110, 120, 130 and the UPF 150.

In FIG. 1, the base stations 100, 110, 120, 130 may provide radio access to terminals which access a network as access nodes of a cellular network. For example, the base stations 100, 110, 120, 130 may collect state information of terminals, such as a buffer state, an available transmission power state, a channel state, and may schedule in order to service traffic of users, and may support a connection between the terminals and a core network (CN) (in particular, a CN of NR may be referred to as 5GC). The base stations 100, 110, 120, 130 may be connected to each other through an Xn interface. The base stations 100, 110, 120, 130 may be connected to 5GC through an NG interface.

In FIG. 1, the gNB 100, 130 may control a plurality of cells, and may apply an adaptive modulation & coding (hereinafter, AMC) scheme to determine a modulation scheme and a channel coding rate according to a channel state of the terminal.

The core network may be a device which is responsible for not only a mobility management function for a terminal but also various control functions, and may be connected with the plurality of base stations. In addition, 5GC may interlock with an existing LTE system.

Meanwhile, in a wireless communication system, a user plane (UP) related to transmission of real user data and a control plane (CP) related to connection management may be separately constituted. In FIG. 1, the gNB 100 and gNB 130 may use the UP and CP technologies defined in the NR technology, and the ng-eNB 110 and ng-eNB 120 may use the UP and CP technologies defined in the long term evolution (LTE) technology although they are connected to 5GC.

The AMF 140 may be a device/node which is responsible for not only a mobility management function for a terminal but also various control functions, and may be connected with the plurality of base stations.

The UPF 150 may refer to a kind of gateway device/node providing data transmission. An NR wireless communication system may include a session management function (SMF) although it is not illustrated in FIG. 1. The SMF may manage a packet data network connection such as a protocol data unit (PDU) session to be provided to a terminal.

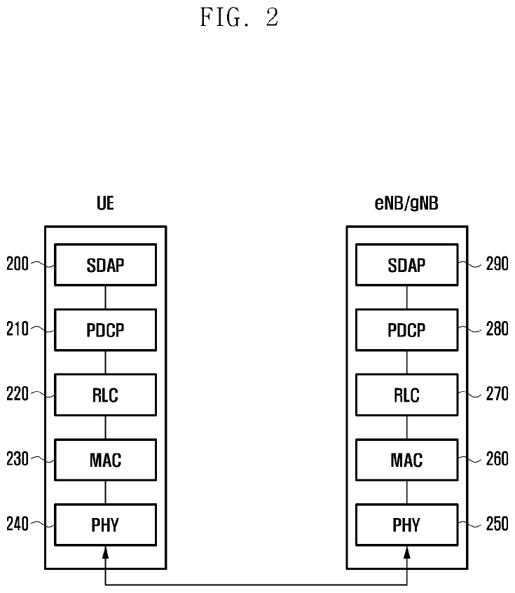

FIG. 2 illustrates a wireless protocol structure in an NR system according to an embodiment of the disclosure.

With reference to FIG. 2, a wireless protocol of an NR system may include, in a terminal and a base station, a service data adaption protocol (SDAP) layer 200, 290, a packet data convergence protocol (PDCP) layer 210, 280, a radio link control (RLC) layer 220, 270, a medium access control (MAC) layer 230, 260, and a physical (PHY) layer 240, 250, respectively.

The service data adaption protocol (SDAP) layer 200, 290 may perform operations for delivering user data, mapping quality of service (QOS) flows to a specific data radio bearer (DRB) for uplink and downlink, marking a QoS flow identifier/identification (ID) for the downlink and uplink, mapping a reflective QoS flow to a data bearer for uplink SDAP PDUs. A SDAP configuration corresponding to each DRB may be provided from a higher RRC layer. It is apparent that the SDAP layer is not limited to the above-described examples.

The packet data convergence protocol (PDCP) layer 210, 280 may be responsible for internet protocol (IP) header compression/decompression operations. In addition, the PDCP layer 210, 280 may provide in-sequence, out-of-sequence delivery functions and may provide reordering, duplicate detection, retransmission, ciphering and deciphering functions. However, it is apparent that the PDCP layer is not limited to the above-described examples.

The radio resource control (RRC) layer 220, 270 may reconstitute PDCP protocol data unit (PDU) to an appropriate size. In addition, the RLC layer 220, 270 may provide in-sequence, out-of-sequence delivery function, as well as automatic repeat request (ARQ) function, concatenation function, segmentation function, reassembly function, re-segmentation function, reordering function, duplication detection function, and error detection function. It is apparent that the RLC layer is not limited to the above-described examples.

The MAC layer 230, 260 may be connected with various RLC layer devices constructed in one terminal, and may perform operations of multiplexing RLC PDUs into MAC PDUs and demultiplexing RLC PDUs from MAC PDUs. In addition, the MAC layer 230, 260 may provide a mapping function, a scheduling information reporting function, a HARQ function, a priority handling function between logical channels, a priority handling function between terminals, a multimedia broadcast multicast service (MBMS) service identification function, a transport format selection function, a padding function. It is apparent that the MAC layer is not limited to the above-described examples.

The physical (PHY) layer 240, 250 may perform an operation for channel-coding and modulating higher layer data to generate an orthogonal frequency division multiplexing (OFDM) symbol and transmitting the OFDM symbol through a wireless channel or demodulating and channel-decoding the OFDM symbol received through the wireless channel and transmitting the demodulated and channel-decoded OFDM symbol to the higher layer. In addition, a hybrid ARQ (HARQ) may be used for additional error correction in the physical layer, and a reception end may transmit information on whether to receive a packet transmitted by a transmission end by using one bit. The one bit information may be referred to as HARQ acknowledgement (ACK)/negative-acknowledgement (NACK) information.

Downlink HARQ ACK/NACK information as to uplink data transmission may be transmitted through a physical hybrid-ARQ indicator channel (PHICH) in the case of LTE. In the case of NR, it may be determined whether retransmission is required or new transmission should be performed through scheduling information of a terminal in a physical dedicated control channel (PDCCH), which is a channel for transmitting downlink/uplink resource allocation, etc. This is because in the NR, an asynchronous HARQ is applied. Uplink HARQ ACK/NACK information as to downlink data transmission may be transmitted through a physical channel such as a physical uplink control channel (PUCCH) or physical uplink shared channel (PUSCH). The PUCCH is normally transmitted through uplink of a PCell which will be described, but, in case where the base station supports a terminal, the PUCCH may be additionally transmitted to a SCell in the corresponding terminal, which will be described below. The SCell is referred to as a PUCCH SCell.

Although not illustrated in FIG. 2, a radio resource control (RRC) layer may exist above the PDCP layer of each of the terminal and base station, and the RRC layer may transmit and receive access and measurement related configuration control messages for radio resource control.

Meanwhile, the physical layer may include one or a plurality of frequencies/carriers, and a technology for configuring and using a plurality of frequencies simultaneously is referred to as a carrier aggregation technology (hereinafter, referred to as CA). One carrier for communication between a terminal (or user equipment (UE)) and a base station (eNB or gNB) has been used, but the CA technology may additionally use a primary carrier and one or a plurality of sub carriers, thereby significantly increasing an amount of data to be transmitted by the number of sub carriers. Meanwhile, in LTE/NR, a cell within a base station that uses a primary carrier may be referred to a primary cell or PCell, and a cell within a base station that uses a sub carrier may be referred to as a secondary cell or SCell.

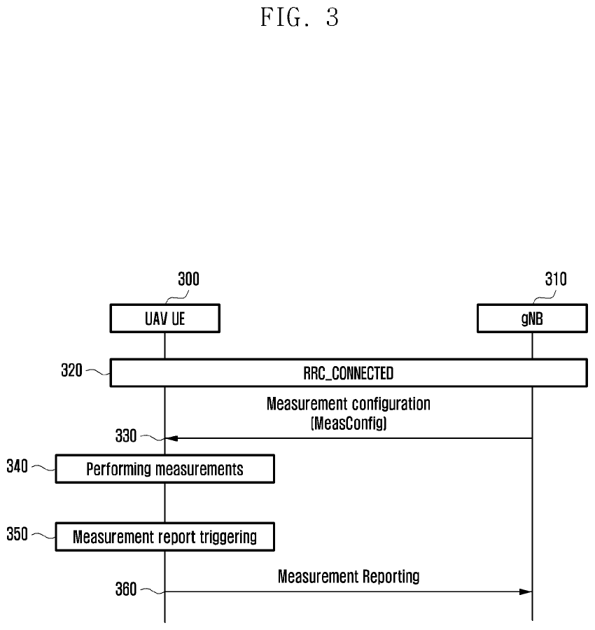

FIG. 3 illustrates an example of a procedure in which an uncrewed aerial vehicle (UAV) terminal transmits a measurement report to a base station in a next-generation mobile communication system according to an embodiment of the disclosure.

With reference to FIG. 3, in operation 320, a UAV terminal 300 may establish an RRC connection with an NR base station 310 and be in an RRC connected mode (RRC_CONNECTED).

In operation 330, a base station may transmit a predetermined RRC message (e.g., RRCResume or RRCReconfiguration) including measurement configuration information (e.g., MeasConfig) to the terminal. For example, MeasConfig may have an abstract syntax notation one (ASN.1) structure as illustrated in Table 1. For example, the MeasConfig may include one or more of the information elements (IE) illustrated in Table 1. Table 1 is an example of a constitution of MeasConfig, and the disclosure is not limited thereto.

TABLE 1
MeasConfig ::= SEQUENCE {

| | |
|---|---|
| measObjectToRemoveList | MeasObjectToRemoveList |

OPTIONAL, -- Need N

| | |
|---|---|
| measObjectToAddModList | MeasObjectToAddModList |

OPTIONAL, -- Need N

| | |
|---|---|
| reportConfigToRemoveList | ReportConfigToRemoveList |

OPTIONAL, -- Need N

| | |
|---|---|
| reportConfigToAddModList | ReportConfigToAddModList |

OPTIONAL, -- Need N

| | |
|---|---|
| measIdToRemoveList MeasIdToRemoveList | OPTIONAL, |

-- Need N

| | |
|---|---|
| measIdToAddModList MeasIdToAddModList | OPTIONAL, |

```
-- Need N
  s-MeasureConfig CHOICE {
    ssb-RSRP RSRP-Range,
    csi-RSRP RSRP-Range
```

| | |
|---|---|
| } | OPTIONAL, -- Need M |
| quantityConfig QuantityConfig | OPTIONAL, |

-- Need M

| | |
|---|---|
| measGapConfig MeasGapConfig | OPTIONAL, |

-- Need M

| | |
|---|---|
| measGapSharingConfig MeasGapSharingConfig | OPTIONAL, |

```
-- Need M
  ...,
  [[
```

| | |
|---|---|
| interFrequencyConfig-NoGap-r16 | ENUMERATED {true} |

OPTIONAL -- Need R
]]
}

| | |
|---|---|
| MeasObjectToRemoveList ::= | SEQUENCE (SIZE (1..maxNrofObjectId)) OF |

MeasObjectId
MeasIdToRemoveList ::= SEQUENCE (SIZE (1..maxNrofMeasId)) OF MeasId

| | |
|---|---|
| ReportConfigToRemoveList ::= | SEQUENCE (SIZE (1..maxReportConfigId)) OF |

ReportConfigId

According to an embodiment of the disclosure, measurement configuration information may include measurement object information (e.g., it may be referred to as measObjectToAddModList) including conditions for the measurement object. The measObjectToAddModList may include one or more MeasObjectToAddMod. For example, the measObjectToAddModList and MeasObjectToAddMod may have an ASN.1 structure as illustrated in Table 2. For example, the measObjectToAddModList and MeasObjectToAddMod may each include one or more of the IEs illustrated in Table 2. Table 2 is an example of a structure of measObjectToAddModList and MeasObjectToAddMod, and the disclosure is not limited thereto.

```
TABLE 2
MeasObjectToAddModList ::= SEQUENCE (SIZE (1..maxNrofObjectId)) OF
MeasObjectToAddMod
MeasObjectToAddMod ::= SEQUENCE {
  measObjectId MeasObjectId,
  measObject CHOICE {
    measObjectNR MeasObjectNR,
    ...,
    measObjectEUTRA MeasObjectEUTRA,
    measObjectUTRA-FDD-r16 MeasObjectUTRA-FDD-r16,
    measObjectNR-SL-r16 MeasObjectNR-SL-r16,
    measObjectCLI-r16 MeasObjectCLI-r16,
    measObjectRxTxDiff-r17 MeasObjectRxTxDiff-r17,
    measObjectRelay-r17 SL-MeasObject-r16
  }
}
```

According to an embodiment of the disclosure, the measurement configuration information may include report configuration information (e.g., it may be referred to as reportConfigToAddModList) including measurement report trigger event configuration and report related configuration information. The reportConfigToAddModList may include one or more ReportConfigToAddMod. For example, the reportConfigToAddModList and ReportConfigToAddMod may have an ASN.1 structure as illustrated in Table 3. For example, the reportConfigToAddModList and ReportConfigToAddMod may each include one or more of the IEs illustrated in Table 3. Table 3 is an example of a structure of reportConfigToAddModList and ReportConfigToAddMod, and the disclosure is not limited thereto.

```
TABLE 3
ReportConfigToAddModList ::= SEQUENCE (SIZE (1..maxReportConfigId)) OF
ReportConfigToAddMod
ReportConfigToAddMod ::= SEQUENCE {
  reportConfigId ReportConfigId,
  reportConfig CHOICE {
    reportConfigNR ReportConfigNR,
    ...,
    reportConfigInterRAT ReportConfigInterRAT,
    reportConfigNR-SL-r16 ReportConfigNR-SL-r16
  }
}
```

According to an embodiment of the disclosure, the ReportConfigToAddMod may include a reportConfig field that configures one of reportConfigId indicating the corresponding ReportConfig and ReportConfig type. For example, the ReportConfigNR, which is a ReportConfig for NR, may have an ASN.1 structure as illustrated in Table 4. For example, the ReportConfigNR may include one or more of the IEs illustrated in Table 4. Table 4 is an example of a structure of ReportConfigNR, and the disclosure is not limited thereto.

```
TABLE 4
ReportConfigNR ::= SEQUENCE {
  reportType CHOICE {
    periodical PeriodicalReportConfig,
    eventTriggered EventTriggerConfig,
    ...,
    reportCGI ReportCGI,
    reportSFTD ReportSFTD-NR,
    condTriggerConfig-r16 CondTriggerConfig-r16,
    cli-Periodical-r16 CLI-PeriodicalReportConfig-r16,
    cli-EventTriggered-r16 CLI-EventTriggerConfig-r16,
    rxTxPeriodical-r17 RxTxPeriodical-r17
  }
}
```

According to an embodiment of the disclosure, the ReportConfigNR may be one of several predetermined reportType. For example, the ReportConfigNR may have the form EventTriggerConfig, which is event-based eventTriggered, one of the reportType. For example, the EventTriggerConfig may have an ASN.1 structure as illustrated in Table 5. For example, the EventTriggerConfig may include one or more of the IEs illustrated in Table 5. Table 5 is an example of a structure of EventTriggerConfig, and the disclosure is not limited thereto.

```
TABLE 5
EventTriggerConfig ::= SEQUENCE {
  eventId CHOICE {
    eventA1 SEQUENCE {
      a1-Threshold MeasTriggerQuantity,
      reportOnLeave BOOLEAN,
      hysteresis Hysteresis,
      timeToTrigger TimeToTrigger
    },
    eventA2 SEQUENCE {
      a2-Threshold MeasTriggerQuantity,
      reportOnLeave BOOLEAN,
      hysteresis Hysteresis,
      timeToTrigger TimeToTrigger
    },
    eventA3 SEQUENCE {
      a3-Offset MeasTriggerQuantityOffset,
      reportOnLeave BOOLEAN,
      hysteresis Hysteresis,
      timeToTrigger TimeToTrigger,
      useAllowedCellList BOOLEAN
    },
    eventA4 SEQUENCE {
      a4-Threshold MeasTriggerQuantity,
      reportOnLeave BOOLEAN,
      hysteresis Hysteresis,
      timeToTrigger TimeToTrigger,
      useAllowedCellList BOOLEAN
    },
    eventA5 SEQUENCE {
      a5-Threshold1 MeasTriggerQuantity,
      a5-Threshold2 MeasTriggerQuantity,
      reportOnLeave BOOLEAN,
      hysteresis Hysteresis,
      timeToTrigger TimeToTrigger,
      useAllowedCellList BOOLEAN
    },
    eventA6 SEQUENCE {
      a6-Offset MeasTriggerQuantityOffset,
      reportOnLeave BOOLEAN,
      hysteresis Hysteresis,
      timeToTrigger TimeToTrigger,
      useAllowedCellList BOOLEAN
    },
    ...,
    [[
    eventX1-r17 SEQUENCE {
      x1-Threshold1-Relay-r17 SL-MeasTriggerQuantity-r16,
      x1-Threshold2-r17 Meas TriggerQuantity,
      reportOnLeave-r17 BOOLEAN,
      hysteresis-r17 Hysteresis,
      timeToTrigger-r17 TimeToTrigger,
      useAllowedCellList-r17 BOOLEAN
    },
    eventX2-r17 SEQUENCE {
      x2-Threshold-Relay-r17 SL-MeasTriggerQuantity-r16,
      reportOnLeave-r17 BOOLEAN,
      hysteresis-r17 Hysteresis,
      timeToTrigger-r17 TimeToTrigger
    },
    eventD1-r17 SEQUENCE {
      distanceThreshFromReference1-r17 INTEGER(1.. 65525),
      distanceThreshFromReference2-r17 INTEGER(1.. 65525),
      referenceLocation1-r17 ReferenceLocation-r17,
      referenceLocation2-r17 ReferenceLocation-r17,
      reportOnLeave-r17 BOOLEAN,
      hysteresisLocation-r17 HysteresisLocation-r17,
      timeToTrigger-r17 TimeToTrigger
    }
    ]]
  },
  rsType NR-RS-Type,
  reportInterval ReportInterval,
  reportAmount ENUMERATED {r1, r2, r4, r8, r16, r32, r64, infinity},
  reportQuantityCell MeasReportQuantity,
  maxReportCells INTEGER (1..maxCellReport),
```

| | |
|---|---|
| reportQuantityRS-Indexes MeasReportQuantity | OPTIONAL, |

-- Need R

| | |
|---|---|
| maxNrofRS-IndexesToReport | INTEGER (1..maxNrofIndexesToReport) |

OPTIONAL, -- Need R
includeBeamMeasurements BOOLEAN,

| | |
|---|---|
| reportAddNeighMeas | ENUMERATED {setup} |

```
OPTIONAL, -- Need R
  ...,
  [[
```

| | |
|---|---|
| measRSSI-ReportConfig-r16 | MeasRSSI-ReportConfig-r16 |

OPTIONAL, -- Need R

| | |
|---|---|
| useT312-r16 BOOLEAN | OPTIONAL, |

-- Need M

| | |
|---|---|
| includeCommonLocationInfo-r16 | ENUMERATED {true} |

OPTIONAL, -- Need R

| | |
|---|---|
| includeBT-Meas-r16 | SetupRelease {BT-NameList-r16} |

OPTIONAL, -- Need M

| | |
|---|---|
| includeWLAN-Meas-r16 | SetupRelease {WLAN-NameList-r16} |

OPTIONAL, -- Need M

| | |
|---|---|
| includeSensor-Meas-r16 | SetupRelease {Sensor-NameList-r16} |

```
OPTIONAL -- Need M
  ]],
  [[
```

| | |
|---|---|
| coarseLocationRequest-r17 | ENUMERATED {true} |

OPTIONAL, -- Need R

| | |
|---|---|
| reportQuantityRelay-r17 | SL-MeasReportQuantity-r16 |

OPTIONAL -- Need R
]]
}

According to an embodiment of the disclosure, the EventTriggerConfig may be composed of an eventId field indicating measurement report trigger event configuration information and other report related configuration fields. For example, the eventId field may indicate corresponding event related configuration information for one event selected from among the A1, A2, A3, A4, A5, A6, X1, X2, and D1 events defined in the NR standard. For example, each event may be as follows:

Event A1: Serving becomes better than absolute threshold;

Event A2: Serving becomes worse than absolute threshold;

Event A3: Neighbour (Neighbor) becomes amount of offset better than PCell(primary cell)/PSCell(primary secondary cell, primary SCG (secondary cell group) cell);

Event A4: Neighbour becomes better than absolute threshold;

Event A5: PCell/PSCell becomes worse than absolute threshold1 AND Neighbour/SCell(secondary cell) becomes better than another absolute threshold2;

Event A6: Neighbour becomes amount of offset better than SCell;

Event X1: Serving L2 (layer 2) U2N (UE to network) Relay UE becomes worse than absolute threshold1 AND NR Cell becomes better than another absolute threshold2;

Event X2: Serving L2 U2N Relay UE becomes worse than absolute threshold; and

Event D1: Distance between UE and a reference location referenceLocation1 becomes larger than configured threshold distanceThreshFromReference1 and distance between UE and a reference location referenceLocation2 becomes shorter than configured threshold distanceThreshFromReference2.

An UAV terminal may operate at a higher location than a terrestrial terminal (UE). Therefore, the UAV terminal may have the characteristic of having a longer visibility range than that of the terrestrial UE. Therefore, the UAV terminal may receive downlink (DL) interference from more cells than the terrestrial UE. In other words, the UAV terminal has the characteristic of receiving a high level of DL interference from more surrounding cells than the terrestrial UE. Likewise, the UAV terminal has the characteristic of causing uplink (hereinafter, UL) interference with more cells than the terrestrial UE.

Therefore, the base station needs to be configured to trigger a measurement report only when the UAV terminal is in a high location. The method/criteria for determining/identifying “when the UAV terminal is at a high location” may refer to the description of an embodiment below. This may mean that in addition to the events defined in the existing NR system, it needs to consider an altitude-based event in the measurement report trigger event for the UAV terminal. In other words, the measurement report trigger event for the UAV terminal may include an altitude-based event (of the UAV terminal) in addition to and/or separately from the event defined in the existing NR standard.

According to an embodiment of the disclosure, in addition to the event defined in the NR standard, event H1 and event H2, which are altitude-based events, may be added to the candidate events of eventId. In this case, the EventTriggerConfig may have an ASN.1 structure as illustrated in Table 6. For example, the EventTriggerConfig may include one or more of the IEs illustrated in Table 6. Table 6 is an example of a structure of EventTriggerConfig, and the disclosure is not limited thereto.

```
TABLE 6
EventTriggerConfig ::= SEQUENCE {
  eventId CHOICE {
    eventA1 SEQUENCE {
      a1-Threshold MeasTriggerQuantity,
      reportOnLeave BOOLEAN,
      hysteresis Hysteresis,
      timeToTrigger TimeToTrigger
    },
    eventA2 SEQUENCE {
      a2-Threshold MeasTriggerQuantity,
      reportOnLeave BOOLEAN,
      hysteresis Hysteresis,
      timeToTrigger TimeToTrigger
    },
    eventA3 SEQUENCE {
      a3-Offset MeasTriggerQuantityOffset,
      reportOnLeave BOOLEAN,
      hysteresis Hysteresis,
      timeToTrigger TimeToTrigger,
      useAllowedCellList BOOLEAN
    },
    eventA4 SEQUENCE {
      a4-Threshold MeasTriggerQuantity,
      reportOnLeave BOOLEAN,
      hysteresis Hysteresis,
      timeToTrigger TimeToTrigger,
      useAllowedCellList BOOLEAN
    },
    eventA5 SEQUENCE {
      a5-Threshold1 MeasTriggerQuantity,
      a5-Threshold2 Meas TriggerQuantity,
      reportOnLeave BOOLEAN,
      hysteresis Hysteresis,
      timeToTrigger TimeToTrigger,
      useAllowedCellList BOOLEAN
    },
    eventA6 SEQUENCE {
      a6-Offset MeasTriggerQuantityOffset,
      reportOnLeave BOOLEAN,
      hysteresis Hysteresis,
      timeToTrigger TimeToTrigger,
      useAllowedCellList BOOLEAN
    },
    ...,
    [[
    eventX1-r17 SEQUENCE {
      x1-Threshold1-Relay-r17 SL-MeasTriggerQuantity-r16,
      x1-Threshold2-r17 MeasTriggerQuantity,
      reportOnLeave-r17 BOOLEAN,
      hysteresis-r17 Hysteresis,
      timeToTrigger-r17 TimeToTrigger,
      useAllowedCellList-r17 BOOLEAN
    },
    eventX2-r17 SEQUENCE {
      x2-Threshold-Relay-r17 SL-MeasTriggerQuantity-r16,
      reportOnLeave-r17 BOOLEAN,
      hysteresis-r17 Hysteresis,
      timeToTrigger-r17 TimeToTrigger
    },
    eventD1-r17 SEQUENCE {
      distanceThreshFromReference1-r17 INTEGER(1.. 65525),
      distanceThreshFromReference2-r17 INTEGER(1.. 65525),
      referenceLocation1-r17 ReferenceLocation-r17,
      referenceLocation2-r17 ReferenceLocation-r17,
      reportOnLeave-r17 BOOLEAN,
      hysteresisLocation-r17 HysteresisLocation-r17,
      timeToTrigger-r17 TimeToTrigger
    }
    ]]
    [[
eventH1 SEQUENCE {
Event H1 configuration information
...
}
eventH2 SEQUENCE {
Event H2 configuration information
...
}
]]
  },
  rsType NR-RS-Type,
  reportInterval ReportInterval,
  reportAmount ENUMERATED {r1, r2, r4, r8, r16, r32, r64, infinity},
  reportQuantityCell MeasReportQuantity,
  maxReportCells INTEGER (1..maxCellReport),
```

| | |
|---|---|
| reportQuantityRS-Indexes MeasReportQuantity | OPTIONAL, |

-- Need R

| | |
|---|---|
| maxNrofRS-IndexesToReport | INTEGER (1..maxNrofIndexesToReport) |

OPTIONAL, -- Need R
includeBeamMeasurements BOOLEAN,

| | |
|---|---|
| reportAddNeighMeas | ENUMERATED {setup} |

```
OPTIONAL, -- Need R
  ...,
  [[
```

| | |
|---|---|
| measRSSI-ReportConfig-r16 | MeasRSSI-ReportConfig-r16 |

OPTIONAL, -- Need R

| | |
|---|---|
| useT312-r16 BOOLEAN | OPTIONAL, |

-- Need M

| | |
|---|---|
| includeCommonLocationInfo-r16 | ENUMERATED {true} |

OPTIONAL, -- Need R

| | |
|---|---|
| includeBT-Meas-r16 | SetupRelease {BT-NameList-r16} |

OPTIONAL, -- Need M

| | |
|---|---|
| includeWLAN-Meas-r16 | SetupRelease {WLAN-NameList-r16} |

OPTIONAL, -- Need M

| | |
|---|---|
| includeSensor-Meas-r16 | SetupRelease {Sensor-NameList-r16} |

```
OPTIONAL -- Need M
  ]],
  [[
```

| | |
|---|---|
| coarseLocationRequest-r17 | ENUMERATED {true} |

OPTIONAL, -- Need R

| | |
|---|---|
| reportQuantityRelay-r17 | SL-MeasReportQuantity-r16 |

OPTIONAL -- Need R
]]
}

According to an embodiment of the disclosure, the eventId field may include configuration information for a specific event. For example, the eventId field may include at least one configuration information among the information below for event H1. For example, the event H1 configuration information in Table 6 (and the disclosure, e.g., Tables 11, 12, 13, 16, and related descriptions) may include at least one of the following information:

heightThreshRef: It may indicate the height threshold value used for entry or leaving condition;

h1-ThresholdOffset: It may indicate an offset value compared to the height threshold used in entry or leaving condition;

h1-Hysteresis: It may indicate a hysteresis value to prevent a ping-pong phenomenon; and

reportOnLeave: It may indicate whether (a terminal) to report a measurement when the leaving condition is satisfied. For example, if it is TRUE, it may indicate to report measurement, and if it is FALSE, it may indicate not to report measurement. As another example, if the reportOnLeave is included, it may be interpreted as an indication that measurement report may be performed, and if the reportOnLeave is not included, it may be interpreted as an indication that measurement reporting may not be performed.

According to an embodiment of the disclosure, the entry and leaving conditions of event H1 that may be indicated by the eventId field may be configured as illustrated in Table 7. In other words, the entry and leaving conditions of event H1 may be configured based on one or more of the contents included in Table 7.

TABLE 7
Entry: consider the entering condition for this event to be satisfied when
condition H1-1, as specified below, is fulfilled;
Leaving: consider the leaving condition for this event to be satisfied when
condition H1-2, as specified below, is fulfilled;
Inequality H1-1 (Entering condition)
Ms − Hys > Thresh + Offset
Inequality H1-2 (Leaving condition)
Ms + Hys < Thresh + Offset
The variables in the formula are defined as follows:
Ms: the Aerial UE height, not taking into account any offsets. Expressed
in meters
Hys: the hysteresis parameter (i.e., h1-Hysteresis) for this event.
Thresh: the reference threshold parameter for this event (i.e.,
heightThreshRef). Expressed in the same unit as Ms
Offset: the offset value to heightThreshRef to obtain the absolute threshold
for this event. (i.e., h1-ThresholdOffset)

According to an embodiment of the disclosure, the eventId field may include at least one configuration information among the following information for event H2. For example, the event H2 configuration information in Table 6 (and this disclosure, e.g., Tables 11, 12, 13, 16, and related descriptions) may include at least one of the information below:

heightThreshRef: It may indicate the height threshold value used for entry or leaving condition;

h2-ThresholdOffset: It may indicate an offset value compared to the height threshold used in entry or leaving condition;

h2-Hysteresis: It may indicate a hysteresis value to prevent a ping-pong phenomenon; And

reportOnLeave: It may indicate whether (a terminal) to report a measurement when the leaving condition is satisfied. For example, if it is TRUE, it may indicate to report measurement, and if it is FALSE, it may indicate not to report measurement. As another example, if the reportOnLeave is included, it may be interpreted as an indication that measurement report may be performed, and if the reportOnLeave is not included, it may be interpreted as an indication that measurement reporting may not be performed.

In an embodiment of the disclosure, the entry and leaving conditions of event H2 that may be indicated by the eventId field may be configured as illustrated in Table 8. That is, the entry and leaving conditions of event H2 may be configured based on one or more of the contents included in Table 8.

TABLE 8
Entry: consider the entering condition for this event to be satisfied when
condition H2-1, as specified below, is fulfilled;
Leaving: consider the leaving condition for this event to be satisfied when
condition H2-2, as specified below, is fulfilled;
Inequality H2-1 (Entering condition)
Ms + Hys < Thresh + Offset
Inequality H2-2 (Leaving condition)
Ms − Hys > Thresh + Offset
The variables in the formula are defined as follows:
Ms: the Aerial UE height, not taking into account any offsets. Expressed
in meters.
Hys: the hysteresis parameter (i.e., h2-Hysteresis) for this event.
Thresh: the reference threshold parameter for this event (i.e.,
heightThreshRef). Expressed in the same unit as Ms.
Offset: the offset value to heightThreshRef to obtain the absolute threshold
for this event. (i.e., h2-ThresholdOffset)

According to an embodiment of the disclosure, measurement configuration information (e.g., MeasConfig) may include measIdToAddModList so that the terminal may add or modify MeasId. The measIdToAddModList may include one or more MeasIdToAddMod. For example, the MeasIdToAddMod may include at least one of one measId field, one measObjectId field, and one reportConfigId field. Accordingly, a specific measId may have an association relationship with the measObject corresponding to the measObjectId and the reportConfig corresponding to the reportConfigId. For example, the MeasIdToAddMod may have an ASN.1 structure as illustrated in Table 9. For example, MeasIdToAddMod may include one or more of the IEs illustrated in Table 9. Table 9 is an example of a structure of MeasIdToAddMod, and the disclosure is not limited thereto.

TABLE 9

```
MeasIdToAddMod ::= SEQUENCE {
  measId MeasId,
  measObjectId MeasObjectId,
reportConfigId ReportConfigId
}
```

With reference again to FIG. 3, for example, in operation 340, the terminal may perform a measurement operation based on measurement configuration information (e.g., MeasConfig) in operation 330.

In operation 350, the terminal may trigger a measurement report based on measurement configuration information (e.g., MeasConfig) configured by the base station in operation 330.

In operation 360, the terminal may transmit the measurement report to the base station based on the measurement configuration information (e.g., MeasConfig) configured in operation 330.

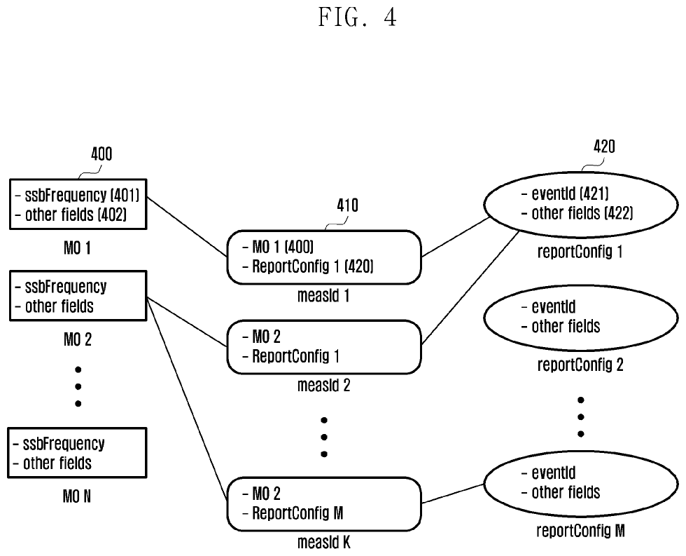

FIG. 4 illustrates an example of the relationship between measObject (MO), measId, and reportConfig, according to an embodiment of the disclosure.

With reference to FIG. 4, for example, a total of N MOs may be configured as MO 1, MO 2, . . . , MO N. Each MO may include measurement frequency (ssbFrequency) and other measurement object related configuration information (other fields). A total of K measId may be configured as measId 1, measId 2, . . . , measId K. Each measId may have an association relationship with one MO and one ReportConfig. A total of M ReportConfig may be configured as reportConfig 1, reportConfig 2, . . . , reportConfig M. Each ReportConfig may include eventId and other report related configuration information (other fields) 422.

With reference to FIG. 4, measId 410 may have an association relationship with one MO (MO 1) 400 indicated by the MeasIdToAddMod and one reportConfig (reportConfig 1) 420 indicated by the MeasIdToAddMod.

For example, the MO 400 may include a measurement frequency (ssbFrequency) 401 and other measurement object related configuration information (other fields 402). The reportConfig 420 may include trigger event configuration information (eventId) 421 and other report related configuration information (other fields) 422.

For example, one MO may have an association relationship with one or more measId, and one reportConfig may have an association relationship with one or more measId. For example, MO 2 may have an association relationship with measId 2 and measId K. For example, reportingConfig 1 may have an association relationship with measId 1 and measId 2.

According to the existing NR standard, there is one reportConfig that has an association relationship with measId. Therefore, since there is one trigger event indicated in reportConfig, a specific measId may have only one measurement report trigger event.

However, the base station may need to trigger a measurement report by an existing event defined in the NR to manage the mobility of the UAV terminal only when the UAV terminal is moving at a high location. Therefore, when triggering a measurement report, a new measurement configuration method may be needed to configure the measurement report to be triggered only when the altitude-based event and the existing event defined in the NR are simultaneously satisfied.

In the disclosure, events being simultaneously satisfied (or considered) may include events being satisfied (or considered) within the same time interval (e.g., a time interval from t1 to t2), as well as events being satisfied (or considered) within different time intervals (e.g., a time interval from t1 to t3 and a time interval from t2 to t4). That is, in the disclosure, events being satisfied (or considered) simultaneously means that a plurality of events is satisfied (or considered), but may not mean that the events must be satisfied (or considered) at the same time or in the same time interval.

According to an embodiment of the disclosure, when a specific measId has an association relationship with a plurality of events, a measurement report including the corresponding measId may be triggered by simultaneously considering the plurality of events.

For example, when a specific measId has an association relationship with a plurality of events, a measurement report including the corresponding measId may be triggered only when the entry conditions of the plurality of events are all satisfied during a specific time (e.g., TimeToTrigger).

For example, when the sizes of TimeToTrigger corresponding to the plurality of events are different, a measurement report including the corresponding measId may be triggered only when the entry conditions of the plurality of events are all satisfied during the TimeToTrigger corresponding to each event.

For example, when the sizes of TimeToTrigger corresponding to the plurality of events are different, the measurement report including the corresponding measId may be triggered only when the entry conditions of the plurality of events are all satisfied during the corresponding time based on the largest value among TimeToTrigger corresponding to each event.

For example, when the sizes of TimeToTrigger corresponding to the plurality of events are different, the measurement report including the corresponding measId may be triggered only when the entry conditions of the plurality of events are all satisfied during the corresponding time based on the smallest value among TimeToTrigger corresponding to each event.

According to an embodiment of the disclosure, when a specific measId has an association relationship with a plurality of events, a measurement report including the corresponding measId may be triggered by simultaneously considering the plurality of events.

For example, among the plurality of events associated with a specific measId, when there is a plurality of events with the reportOnLeave configured to TRUE, a measurement report including the corresponding measId may be triggered only when the leaving conditions of the plurality of events with the reportOnLeave configured to TRUE are all satisfied during a specific time (Time ToTrigger).

For example, when the sizes of the TimeToTrigger corresponding to the plurality of events with reportOnLeave configured to TRUE are different, a measurement report including the corresponding measId may be triggered only when the leaving conditions of the plurality of events with the reportOnLeave configured to TRUE are all satisfied during TimeToTrigger corresponding to each event.

For example, when the sizes of the TimeToTrigger corresponding to the plurality of events with the reportOnLeave configured to TRUE are different, a measurement report including the corresponding measId may be triggered only when the leaving conditions of the plurality of events with the reportOnLeave configured to TRUE are all satisfied, based on the largest value among TimeToTrigger corresponding to each event, during the corresponding time.

For example, when the sizes of the TimeToTrigger corresponding to the plurality of events with the reportOnLeave configured to TRUE are different, a measurement report including the corresponding measId may be triggered only when the leaving conditions of the plurality of events with the reportOnLeave configured to TRUE are all satisfied, based on the smallest value among TimeToTrigger corresponding to each event, during the corresponding time.

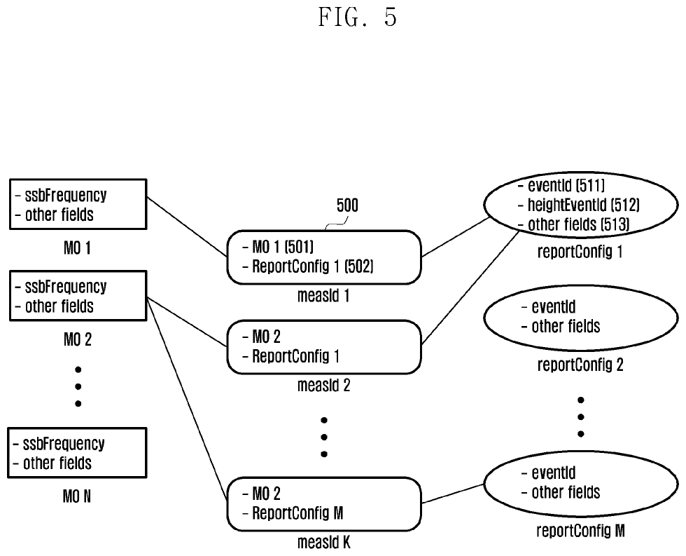

FIG. 5 is a diagram illustrating an example of a relationship between measId, MO, and reportConfig including a plurality of trigger event configuration information according to an embodiment of the disclosure. Detailed descriptions of content that overlaps with the content illustrated in FIG. 4 will be omitted.

With reference to FIG. 5, a specific measId (measId 1) 500 may have an association relationship with one MO (MO 1) 501 and one reportConfig (reportConfig 1) 502 indicated by the corresponding MeasIdToAddMod. In this case, the structure of the reportConfig associated with the corresponding measId may be changed or expanded so that the corresponding measId 500 may have a plurality of trigger events (eventId 511, heightEventId 512).

A specific measId may have an association relationship with the reportConfig indicated by the corresponding MeasIdToAddMod. The associated reportConfig may be configured to ReportConfigNR. The reportType of ReportConfigNR may be configured to EventTriggerConfig. The EventTriggerConfig may be extended to indicate a plurality of event configuration information by defining a plurality of eventId fields in the EventTriggerConfig. In this case, a measurement report including the corresponding measId may be triggered by simultaneously considering the plurality of events indicated by the EventTriggerConfig.

For example, the EventTriggerConfig may include two eventId fields.

For example, a first eventId field may be an eventId indicating one of A1, A2, A3, A4, A5, A6, X1, X2, and D1, and a second eventId field may be an eventId indicating an altitude-based event (one of H1 and H2).

For example, the first eventId field may be an eventId indicating one of A1, A2, A3, A4, A5, A6, X1, X2, D1, H1, and H2, and the second eventId field may be an eventId indicating one of A1, A2, A3, A4, A5, A6, X1, X2, D1, H1, and H2.

For example, only one of the first eventId field and the second eventId field may be limited to indicate the altitude-based Event (H1, H2).

For example, an additionally configured eventId field may or may not exist as an optional field. For example, one of the two eventId fields in the EventTriggerConfig may be the optional field.

For example, the first or second eventId field (e.g., it may be referred to as heightEventId) of the EventTriggerConfig may indicate eventH1 or eventH2. In this case, the eventH1 may indicate event H1 configuration information, and the eventH2 may indicate event H2 configuration information. For example, the EventTriggerConfig may have an ASN.1 structure as illustrated in Table 10. For example, the EventTriggerConfig may include one or more of the IEs illustrated in Table 10. Table 10 is an example of a structure of EventTriggerConfig, and the disclosure is not limited thereto.

```
TABLE 10
EventTriggerConfig::= SEQUENCE {
  eventId CHOICE {
    eventA1 SEQUENCE {
      a1-Threshold MeasTriggerQuantity,
      reportOnLeave BOOLEAN,
      hysteresis Hysteresis,
      timeToTrigger TimeToTrigger
    },
    eventA2 SEQUENCE {
      a2-Threshold MeasTriggerQuantity,
      reportOnLeave BOOLEAN,
      hysteresis Hysteresis,
      timeToTrigger TimeToTrigger
    },
    eventA3 SEQUENCE {
      a3-Offset MeasTriggerQuantityOffset,
      reportOnLeave BOOLEAN,
      hysteresis Hysteresis,
      timeToTrigger TimeToTrigger,
      useAllowedCellList BOOLEAN
    },
    eventA4 SEQUENCE {
      a4-Threshold MeasTriggerQuantity,
      reportOnLeave BOOLEAN,
      hysteresis Hysteresis,
      timeToTrigger TimeToTrigger,
      useAllowedCellList BOOLEAN
    },
    eventA5 SEQUENCE {
      a5-Threshold1 MeasTriggerQuantity,
      a5-Threshold2 MeasTriggerQuantity,
      reportOnLeave BOOLEAN,
      hysteresis Hysteresis,
      timeToTrigger TimeToTrigger,
      useAllowedCellList BOOLEAN
    },
    eventA6 SEQUENCE {
      a6-Offset MeasTriggerQuantityOffset,
      reportOnLeave BOOLEAN,
      hysteresis Hysteresis,
      timeToTrigger TimeToTrigger,
      useAllowedCellList BOOLEAN
    },
    ...,
    [[
    eventX1-r17 SEQUENCE {
      x1-Threshold1-Relay-r17 SL-MeasTriggerQuantity-r16,
      x1-Threshold2-r17 MeasTriggerQuantity,
      reportOnLeave-r17 BOOLEAN,
      hysteresis-r17 Hysteresis,
      timeToTrigger-r17 TimeToTrigger,
      useAllowedCellList-r17 BOOLEAN
    },
    eventX2-r17 SEQUENCE {
      x2-Threshold-Relay-r17 SL-MeasTriggerQuantity-r16,
      reportOnLeave-r17 BOOLEAN,
      hysteresis-r17 Hysteresis,
      timeToTrigger-r17 TimeToTrigger
    },
    eventD1-r17 SEQUENCE {
      distanceThreshFromReference1-r17 INTEGER(1.. 65525),
      distanceThreshFromReference2-r17 INTEGER(1.. 65525),
      referenceLocation1-r17 ReferenceLocation-r17,
      referenceLocation2-r17 ReferenceLocation-r17,
      reportOnLeave-r17 BOOLEAN,
      hysteresisLocation-r17 HysteresisLocation-r17,
      timeToTrigger-r17 TimeToTrigger
    }
    ]]
  },
  rsType NR-RS-Type,
  reportInterval ReportInterval,
  reportAmount ENUMERATED {r1, r2, r4, 8, r16, r32, r64, infinity},
  reportQuantityCell MeasReportQuantity,
  maxReportCells INTEGER (1..maxCellReport),
```

| | |
|---|---|
| reportQuantityRS-Indexes MeasReportQuantity | OPTIONAL, |

-- Need R

| | |
|---|---|
| maxNrofRS-IndexesToReport | INTEGER (1..maxNrofIndexesToReport) |

OPTIONAL, -- Need R
includeBeamMeasurements BOOLEAN,

| | |
|---|---|
| reportAddNeighMeas | ENUMERATED {setup} |

```
OPTIONAL, -- Need R
  ...,
  [[
```

| | |
|---|---|
| measRSSI-ReportConfig-r16 | MeasRSSI-ReportConfig-r16 |

OPTIONAL, -- Need R

| | |
|---|---|
| useT312-r16 BOOLEAN | OPTIONAL, |

-- Need M

| | |
|---|---|
| includeCommonLocationInfo-r16 | ENUMERATED {true} |

OPTIONAL, -- Need R

| | |
|---|---|
| includeBT-Meas-r16 | SetupRelease {BT-NameList-r16} |

OPTIONAL, -- Need M

| | |
|---|---|
| includeWLAN-Meas-r16 | SetupRelease {WLAN-NameList-r16} |

OPTIONAL, -- Need M

| | |
|---|---|
| includeSensor-Meas-r16 | SetupRelease {Sensor-NameList-r16} |

```
OPTIONAL -- Need M
  ]],
  [[
```

| | |
|---|---|
| coarseLocationRequest-r17 | ENUMERATED {true} |

OPTIONAL, -- Need R

| | |
|---|---|
| reportQuantityRelay-r17 | SL-MeasReportQuantity-r16 |

OPTIONAL -- Need R
]]
[[
heightEventId CHOICE {
eventH1 SEQUENCE {
Event H1 configuration information
}
eventH2 SEQUENCE {
Event H2 configuration information
}

| | |
|---|---|
| ]] | OPTIONAL -- |

Need R
}

For example, a specific measId may have an association relationship with the reportConfig indicated by the corresponding MeasIdToAddMod. The associated reportConfig may be configured to ReportConfigNR. The reportType of ReportConfigNR may be configured to a newly defined reportType (e.g., it may be called EventTriggerConfigUAV). The EventTriggerConfigUAV may indicate a plurality of pieces of event configuration information with a plurality of eventId fields. Accordingly, a measurement report including the corresponding measId may be triggered by simultaneously considering the plurality of events indicated by the EventTriggerConfigUAV.

For example, the EventTriggerConfigUAV may include two eventId fields 511, 512.

For example, the first eventId field 511 may be an eventId indicating one of A1, A2, A3, A4, A5, A6, X1, X2 and D1, and the second eventId field 512 may be an eventId field indicating an altitude-based event (one of H1 and H2).

For example, the first eventId field 511 may indicate one of A1, A2, A3, A4, A5, A6, X1, X2, D1, H1, and H2, and the second eventId field 512 may indicate one of A1, A2, A3, A4, A5, A6, X1, X2, D1, H1, and H2.

For example, only one of the two eventId fields may be restricted to indicate the altitude-based event. For example, one of the two eventId fields may indicate eventH1 or eventH2. In this case, eventH1 may indicate event H1 configuration information, and eventH2 may indicate event H2 configuration information.

For example, the EventTriggerConfigUAV may include other report related fields (other fields) 513, in addition to the plurality of eventId fields 511, 512. For example, the EventTriggerConfigUAV may include the other report related fields 513, in addition to and/or separately from the plurality of eventId fields 511, 512.

For example, the EventTriggerConfigUAV may have an ASN.1 structure as illustrated in Table 11. For example, the EventTriggerConfigUAV may include one or more of the IEs illustrated in Table 11. Table 11 is an example of a structure of EventTriggerConfigUAV, and the disclosure is not limited thereto.

```
TABLE 11
ReportConfigNR ::= SEQUENCE {
  reportType CHOICE {
    periodical PeriodicalReportConfig,
    eventTriggered EventTriggerConfig,
    ...,
    reportCGI ReportCGI,
    reportSFTD ReportSFTD-NR,
    condTriggerConfig-r16 CondTriggerConfig-r16,
    cli-Periodical-r16 CLI-PeriodicalReportConfig-r16,
    cli-EventTriggered-r16 CLI-EventTriggerConfig-r16,
    rxTxPeriodical-r17 RxTxPeriodical-r17,
    eventTriggeredUAV
EventTriggerConfigUAV
}
}
EventTriggerConfigUAV::= SEQUENCE {
  eventId CHOICE {
    eventA1 SEQUENCE {
      a1-Threshold MeasTriggerQuantity,
      reportOnLeave BOOLEAN,
      hysteresis Hysteresis,
      timeToTrigger TimeToTrigger
    },
    eventA2 SEQUENCE {
      a2-Threshold MeasTriggerQuantity,
      reportOnLeave BOOLEAN,
      hysteresis Hysteresis,
      timeToTrigger TimeToTrigger
    },
    eventA3 SEQUENCE {
      a3-Offset MeasTriggerQuantityOffset,
      reportOnLeave BOOLEAN,
      hysteresis Hysteresis,
      timeToTrigger TimeToTrigger,
      useAllowedCellList BOOLEAN
    },
    eventA4 SEQUENCE {
      a4-Threshold MeasTriggerQuantity,
      reportOnLeave BOOLEAN,
      hysteresis Hysteresis,
      timeToTrigger TimeToTrigger,
      useAllowedCellList BOOLEAN
    },
    eventA5 SEQUENCE {
      a5-Threshold1 MeasTriggerQuantity,
      a5-Threshold2 MeasTriggerQuantity,
      reportOnLeave BOOLEAN,
      hysteresis Hysteresis,
      timeToTrigger TimeToTrigger,
      useAllowedCellList BOOLEAN
    },
    eventA6 SEQUENCE {
      a6-Offset MeasTriggerQuantityOffset,
      reportOnLeave BOOLEAN,
      hysteresis Hysteresis,
      timeToTrigger TimeToTrigger,
      useAllowedCellList BOOLEAN
    },
    ...,
    [[
    eventX1-r17 SEQUENCE {
      x1-Threshold1-Relay-r17 SL-MeasTriggerQuantity-r16,
      x1-Threshold2-r17 MeasTriggerQuantity,
      reportOnLeave-r17 BOOLEAN,
      hysteresis-r17 Hysteresis,
      timeToTrigger-r17 TimeToTrigger,
      useAllowedCellList-r17 BOOLEAN
    },
    eventX2-r17 SEQUENCE {
      x2-Threshold-Relay-r17 SL-MeasTriggerQuantity-r16,
      reportOnLeave-r17 BOOLEAN,
      hysteresis-r17 Hysteresis,
      timeToTrigger-r17 TimeToTrigger
    },
    eventD1-r17 SEQUENCE {
      distanceThreshFromReference1-r17 INTEGER(1.. 65525),
      distanceThreshFromReference2-r17 INTEGER(1.. 65525),
      referenceLocation1-r17 ReferenceLocation-r17,
      referenceLocation2-r17 ReferenceLocation-r17,
      reportOnLeave-r17 BOOLEAN,
      hysteresisLocation-r17 HysteresisLocation-r17,
      timeToTrigger-r17 TimeToTrigger
    }
    ]]
},
heightEventId CHOICE {
eventH1 SEQUENCE {
Event H1 configuration information
}
eventH2 SEQUENCE {
Event H2 configuration information
}
}
  rsType NR-RS-Type,
  reportInterval ReportInterval,
  reportAmount ENUMERATED {r1, r2, r4, r8, r16, r32, r64, infinity},
  reportQuantityCell MeasReportQuantity,
  maxReportCells INTEGER (1..maxCellReport),
```

| | |
|---|---|
| reportQuantityRS-Indexes MeasReportQuantity | OPTIONAL, |
| -- Need R | |
| maxNrofRS-IndexesToReport | INTEGER (1..maxNrofIndexesToReport) |
| OPTIONAL, -- Need R | |
| includeBeamMeasurements BOOLEAN, | |
| reportAddNeighMeas | ENUMERATED {setup} |
| OPTIONAL, -- Need R | |
| ..., | |
| [[ | |
| measRSSI-ReportConfig-r16 | MeasRSSI-ReportConfig-r16 |
| OPTIONAL, -- Need R | |
| useT312-r16 BOOLEAN | OPTIONAL, |
| -- Need M | |
| includeCommonLocationInfo-r16 | ENUMERATED {true} |
| OPTIONAL, -- Need R | |
| includeBT-Meas-r16 | SetupRelease {BT-NameList-r16} |
| OPTIONAL, -- Need M | |
| includeWLAN-Meas-r16 | SetupRelease {WLAN-NameList-r16} |
| OPTIONAL, -- Need M | |
| includeSensor-Meas-r16 | SetupRelease {Sensor-NameList-r16} |
| OPTIONAL -- Need M | |
| ]], | |
| [[ | |
| coarseLocationRequest-r17 | ENUMERATED {true} |
| OPTIONAL, -- Need R | |
| reportQuantityRelay-r17 | SL-MeasReportQuantity-r16 |
| OPTIONAL -- Need R | |
| ]] | |
| } | |

According to an embodiment of the disclosure described above, since one ReportConfig is connected to one measId, compared to connecting a plurality of ReportConfig, there may be an advantage in not having to configure the fields overlapped in each ReportConfig on the terminal multiple times.

For example, the EventTriggerConfigUAV may include only one eventId field. For example, the EventTriggerConfigUAV may include one eventId field rather than a plurality of eventId fields. For example, the EventTriggerConfigUAV may not include other report related fields other than one eventId field. For example, the eventId field of EventTriggerConfigUAV may only indicate the altitude-based event.

For example, the EventTriggerConfigUAV may have an ASN.1 structure as illustrated in Table 12. For example, the EventTriggerConfigUAV may include one or more of the IEs illustrated in Table 12. Table 12 is an example of a structure of EventTriggerConfigUAV, and the disclosure is not limited thereto.

TABLE 12

```
ReportConfigNR ::= SEQUENCE {
reportType CHOICE {
periodical PeriodicalReportConfig,
eventTriggered EventTriggerConfig,
...,
reportCGI ReportCGI,
reportSFTD ReportSFTD-NR,
condTriggerConfig-r16 CondTriggerConfig-r16,
cli-Periodical-r16 CLI-PeriodicalReportConfig-r16,
cli-EventTriggered-r16 CLI-EventTriggerConfig-r16,
rxTxPeriodical-r17 RxTxPeriodical-r17,
eventTriggeredUAV
EventTriggerConfigUAV
}
}
EventTriggerConfigUAV::= SEQUENCE {
  eventId CHOICE {
    eventH1 SEQUENCE {
      Event H1 configuration information
}
eventH2 SEQUENCE {
      Event H2 configuration information
}
}
}
```

For example, the EventTriggerConfigUAV may include only one eventId field. For example, the EventTriggerConfigUAV may include one eventId field rather than a plurality of eventId fields. For example, the EventTriggerConfigUAV may not include other report related fields other than one eventId field. For example, the eventId field of EventTriggerConfigUAV may indicate either the altitude-based event or all events defined in the existing NR.

For example, the EventTriggerConfigUAV may have an ASN.1 structure as illustrated in Table 13. For example, the EventTriggerConfigUAV may include one or more of the IEs illustrated in Table 13. Table 13 is an example of a structure of EventTriggerConfigUAV, and the disclosure is not limited thereto.

TABLE 13

```
ReportConfigNR ::= SEQUENCE {
  reportType CHOICE {
    periodical PeriodicalReportConfig,
    eventTriggered EventTriggerConfig,
    ...,
    reportCGI ReportCGI,
    reportSFTD ReportSFTD-NR,
    condTriggerConfig-r16 CondTriggerConfig-r16,
    cli-Periodical-r16 CLI-PeriodicalReportConfig-r16,
    cli-EventTriggered-r16 CLI-EventTriggerConfig-r16,
    rxTxPeriodical-r17 RxTxPeriodical-r17,
    eventTriggeredUAV
EventTriggerConfigUAV
}
}
EventTriggerConfigUAV::= SEQUENCE {
  eventId CHOICE {
    eventA1 SEQUENCE {
      a1-Threshold MeasTriggerQuantity,
      reportOnLeave BOOLEAN,
      hysteresis Hysteresis,
      timeToTrigger TimeToTrigger
    },
    eventA2 SEQUENCE {
      a2-Threshold MeasTriggerQuantity,
      reportOnLeave BOOLEAN,
      hysteresis Hysteresis,
      timeToTrigger TimeToTrigger
    },
    eventA3 SEQUENCE {
      a3-Offset MeasTriggerQuantityOffset,
      reportOnLeave BOOLEAN,
      hysteresis Hysteresis,
      timeToTrigger TimeToTrigger,
      useAllowedCellList BOOLEAN
    },
    eventA4 SEQUENCE {
      a4-Threshold MeasTriggerQuantity,
      reportOnLeave BOOLEAN,
      hysteresis Hysteresis,
      timeToTrigger TimeToTrigger,
      useAllowedCellList BOOLEAN
    },
    eventA5 SEQUENCE {
      a5-Threshold1 Meas TriggerQuantity,
      a5-Threshold2 Meas TriggerQuantity,
      reportOnLeave BOOLEAN,
      hysteresis Hysteresis,
      timeToTrigger TimeToTrigger,
      useAllowedCellList BOOLEAN
    },
    eventA6 SEQUENCE {
      a6-Offset MeasTriggerQuantityOffset,
      reportOnLeave BOOLEAN,
      hysteresis Hysteresis,
      timeToTrigger TimeToTrigger,
      useAllowedCellList BOOLEAN
    },
    ...,
    [[
    eventX1-r17 SEQUENCE {
      x1-Threshold1-Relay-r17 SL-MeasTriggerQuantity-r16,
      x1-Threshold2-r17 MeasTriggerQuantity,
      reportOnLeave-r17 BOOLEAN,
      hysteresis-r17 Hysteresis,
      timeToTrigger-r17 TimeToTrigger,
      useAllowedCellList-r17 BOOLEAN
    },
    eventX2-r17 SEQUENCE {
      x2-Threshold-Relay-r17 SL-MeasTriggerQuantity-r16,
      reportOnLeave-r17 BOOLEAN,
      hysteresis-r17 Hysteresis,
      timeToTrigger-r17 TimeToTrigger
    },
    eventD1-r17 SEQUENCE {
      distanceThreshFromReference1-r17 INTEGER(1.. 65525),
      distanceThreshFromReference2-r17 INTEGER(1.. 65525),
      referenceLocation1-r17 ReferenceLocation-r17,
      referenceLocation2-r17 ReferenceLocation-r17,
      reportOnLeave-r17 BOOLEAN,
      hysteresisLocation-r17 HysteresisLocation-r17,
      timeToTrigger-r17 TimeToTrigger
    }
    ]]
[[
    eventH1 SEQUENCE {
      Event H1 configuration information
}
eventH2 SEQUENCE {
      Event H2 configuration information
}
]]
}
}
```

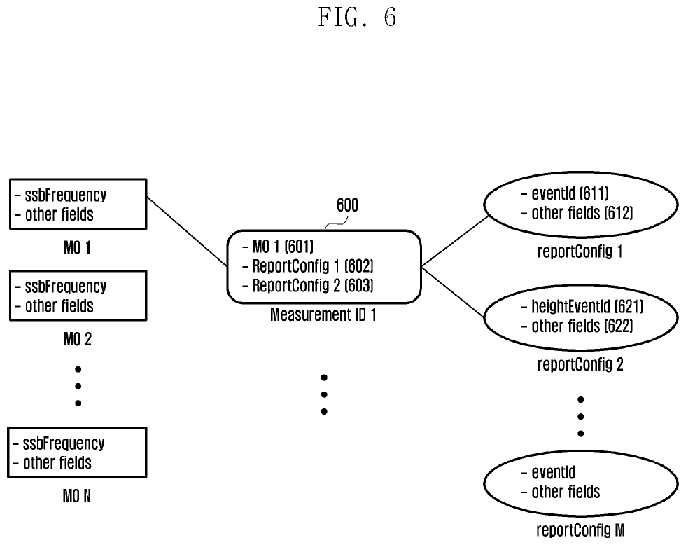

FIG. 6 illustrates an example of a structure in which one measId has an association relationship with a plurality of reportConfig, according to an embodiment of the disclosure. Detailed descriptions of content that overlaps with the content illustrated in FIGS. 4 and 5 will be omitted.

With reference to FIG. 6, a specific measId (measurement ID) may have an association relationship with one MO and a plurality of reportConfig. The measId may regard all respective events indicated by the plurality of reportConfig as measurement report trigger events. Accordingly, a measurement report including the measId may be triggered by considering the plurality of events together.

For example, measurement ID 1 600 may have an association relationship with one MO 1 (601) and two reportConfig (reportConfig 1 602, reportConfig 2 603). The reportConfig 1 602 may include eventId 611 and other report related fields (other fields) 612. The reportConfig 2 603 may include heightEventId 621 and other report related fields (other fields) 622. In the measurement ID 1 600, both the eventId 611 and heightEventId 621 indicated in the reportConfig 1 602 and reportConfig 2 603 may correspond to measurement report trigger events.

According to one embodiment of the disclosure, MeasIdToAddModListExt is newly defined, and a corresponding field (e.g., it may be referred to as measIdToAddModListExt) may be added to MeasConfig.

For example, the measIdToAddModListExt may include one or more MeasIdToAddModExt.

For example, the MeasIdToAddModExt may be introduced for the purpose of adding new fields in addition to existing fields to the MeasIdToAddMod. In this case, the field of MeasIdToAddModExt may be interpreted as an additional field of MeasIdToAddMod.

For example, the number of MeasIdToAddModExt included in the measIdToAddModListExt may be the same as the number of MeasIdToAddMod included in the measIdToAddModList included in the same MeasConfig.

For example, the order of MeasIdToAddModExt included in the measIdToAddModListExt may be the same as the order of the corresponding MeasIdToAddMod included in the measIdToAddModList. In other words, the measIdToAddModListExt may be interpreted as follows.

If measIdToAddModListExt is configured, it contains the same number of entries, and in the same order, as measIdToAddModList

For example, MeasConfig and MeasIdToAddModListExt may have an ASN.1 structure as illustrated in Table 14. For example, the MeasConfig and MeasIdToAddModListExt may each include one or more of the IEs illustrated in Table 14. Table 14 is an example of each structure of MeasConfig and MeasIdToAddModListExt, and the disclosure is not limited thereto.

TABLE 14
MeasConfig ::= SEQUENCE {

| | |
|---|---|
| measObjectToRemoveList | MeasObjectToRemoveList |

OPTIONAL, -- Need N

| | |
|---|---|
| measObjectToAddModList | MeasObjectToAddModList |

OPTIONAL, -- Need N

| | |
|---|---|
| reportConfigToRemoveList | ReportConfigToRemoveList |

OPTIONAL, -- Need N

| | |
|---|---|
| reportConfigToAddModList | ReportConfigToAddModList |

OPTIONAL, -- Need N

| | |
|---|---|
| measIdToRemoveList MeasIdToRemoveList | OPTIONAL, |

-- Need N

| | |
|---|---|
| measIdToAddModList MeasIdToAddModList | OPTIONAL, |

```
-- Need N
  s-MeasureConfig CHOICE {
    ssb-RSRP RSRP-Range,
    csi-RSRP RSRP-Range
```

| | |
|---|---|
| } | OPTIONAL, -- Need M |
| quantityConfig QuantityConfig | OPTIONAL, |

-- Need M

| | |
|---|---|
| measGapConfig MeasGapConfig | OPTIONAL, |

-- Need M

| | |
|---|---|
| measGapSharingConfig MeasGapSharingConfig | OPTIONAL, |

-- Need M

| | |
|---|---|
| ..., | |
| [[ | |
| interFrequencyConfig-NoGap-r16 | ENUMERATED {true} |

```
OPTIONAL, -- Need R
  ]],
  [[
  measIdToAddModListExt MeasIdToAddModListExt OPTIONAL, -- Need N
```

| | |
|---|---|
| ]] | |
| } | |
| MeasIdToAddModListExt ::= | SEQUENCE (SIZE (1..maxNrofMeasId)) OF |
| MeasIdToAddModExt | |

For example, the MeasIdToAddModExt may include a reportConfigIdList field that indicates one or more reportConfig. The reportConfigIdList field may include one or more ReportConfigId. Accordingly, a specific measId may have an association relationship with both the reportConfig indicated by the corresponding MeasIdToAddMod and one or more reportConfig indicated by the corresponding MeasIdToAddModExt.

For example, when a specific measId has an association relationship with a plurality of reportConfig, the corresponding measId may have an association relationship with all of the plurality of events indicated by the plurality of associated reportConfig.

For example, the reportConfigIdList of MeasIdToAddModExt is an optional field and may or may not exist.

For example, the MeasIdToAddModExt may have the following ASN.1 structure. For example, the MeasIdToAddModExt may include one or more of the IEs illustrated in Table 15. Table 15 is an example of a structure of MeasIdToAddModExt, and the disclosure is not limited thereto.

TABLE 15
MeasIdToAddModExt ::= SEQUENCE {
reportConfigIdList SEQUENCE (SIZE (1..maxReportConfigId)) OF
ReportConfigId OPTIONAL, -- Need N
}

For example, when a specific measId has an association relationship with a plurality of reportConfig, a field that is configured multiple times may exist as a field in common (common field) of the plurality of reportConfig. In this case, for example, the base station may configure the common field to have the same value in all reportConfig. For example, when the common field has a numerical value, it may be configured when a measurement report including the corresponding measId is performed based on the smallest value among the values configured in the plurality of reportConfig for the corresponding field. That is, the value of the common field may be configured based on the smallest value among the values configured in the plurality of reportConfig. For example, when the common field has a numerical value, it may be configured when a measurement report including the corresponding measId is performed based on the largest value among the values configured in the plurality of reportConfig for the corresponding field. That is, the value of the common field may be configured based on the largest value among the values configured in the plurality of reportConfig.

For example, when a specific measId has an association relationship with a plurality of reportConfigs, one reportConfig of the plurality of reportConfig is considered as a reference reportConfig, and measurement reporting may be performed based on the reference reportConfig. For example, the reference reportConfig may be the reportConfig indicated by MeasIdToAddMod corresponding to the corresponding measId. For example, the base station may explicitly indicate the reference reportConfig by adding a new field (e.g., refReportConfigId) to measConfig.

For example, when a specific measId has an association relationship with a plurality of reportConfig, a method for solving problems arising from the common field of the plurality of reportConfig may be provided. For example, when a specific measId has an association relationship with the plurality of reportConfig, the reportType of only one reportConfig among them may be configured to EventTriggerConfig, and the reportType of the other reportConfig may be configured to EventTriggerConfigUAV, which is a new reportType. For example, the EventTriggerConfigUAV may include only one eventId field. For example, the eventId field of the EventTriggerConfigUAV may indicate only the altitude-based event. For example, the eventId field of the EventTriggerConfigUAV may indicate one of the altitude-based event and all events defined in the NR standard.

According to an embodiment of the disclosure described above, when allocating a new measId, a preconfigured reportConfig may be reused, so there may be an advantage in that base station configuration is flexible. Additionally, in terms of terminal implementation, there may be an advantage in that it may be easily identified that the plurality of reportConfig is associated with one measId.

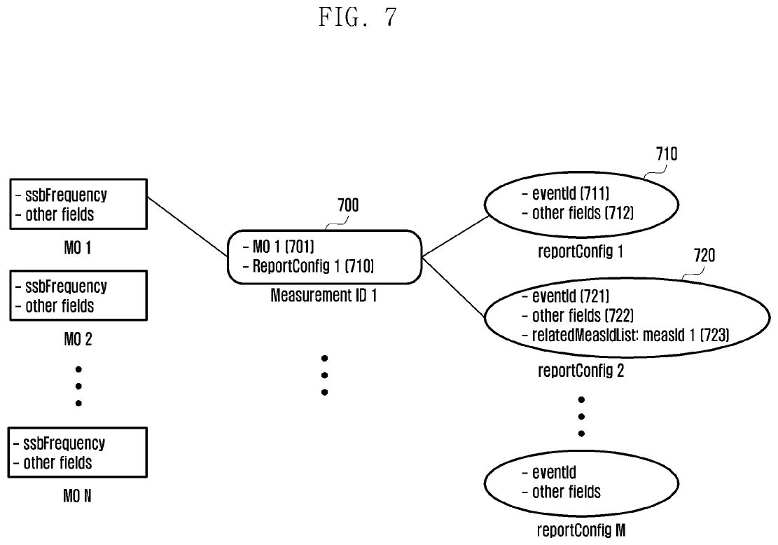

FIG. 7 illustrates an example of a structure in which one measId may have an association relationship with events indicated in a plurality of reportConfig, according to an embodiment of the disclosure. Detailed descriptions of content that overlaps with the content illustrated in FIGS. 4 to 6 will be omitted.

With reference to FIG. 7, a specific reportConfig may be configured to ReportConfigNR, and the reportType of ReportConfigNR may be configured to EventTriggerConfig. A measId List (e.g., it may be referred to as relatedMeasIdList) indicating one or more measId is added to the EventTriggerConfig, so that an association relationship may be additionally configured between each measId included in the relatedMeasIdList and the event indicated by the EventTriggerConfig. In this case, each measId included in the relatedMeasIdList may have an association relationship with both the event of reportConfig indicated by the corresponding measIdToAddMod and the event of EventTriggerConfig including the relatedMeasIdList. For example, a measId List (e.g., it may be referred to as relatedMeasIdList) indicating one or more measId is added to the EventTriggerConfig, so that an association relationship may be additionally established between each measId included in the corresponding relatedMeasIdList and the reportConfig including the corresponding EventTriggerConfig.

For example, the relatedMeasIdList of EventTriggerConfig is an optional field and may or may not exist.

For example, when the relatedMeasIdList includes a plurality of measId, all of the plurality of measId may have an association relationship with the event of the EventTriggerConfig including the relatedMeasIdList.

With reference to FIG. 7, measId 1 (measurement ID 1) 700 may have an association relationship with event(eventId) 711 of ReportConfig (reportConfig 1 710) indicated by the corresponding measIdToAddMod. The ReportConfig 1 710 may include eventId 711 and other report related fields (other fields) 712. ReportConfig 2 720 may include relatedMeasIdList in the EventTriggerConfig, and in this case, the measId 1 723 may be included in the corresponding field (that is, the ReportConfig 2 720 may include eventId 721, other report related field 722, and relatedMeasIdList (including measId 1 723)). Therefore, measId 1 may have an association relationship with the event corresponding to the eventId of EventTriggerConfig including the relatedMeasIdList. Therefore, measId 1 may have the two measurement report trigger events 711, 721. For example, the EventTriggerConfig including the relatedMeasIdList may indicate only the altitude-based event. For example, the EventTriggerConfig including the relatedMeasIdList may indicate one of the altitude-based event and all (or at least some) events defined in NR. For example, the EventTriggerConfig including the relatedMeasIdList may have an ASN.1 structure as illustrated in Table 16. For example, the EventTriggerConfig including the relatedMeasIdList may include one or more of the IEs illustrated in Table 16. Table 16 is an example of a structure of EventTriggerConfig including the relatedMeasIdList, and the disclosure is not limited thereto.

```
TABLE 16
EventTriggerConfig::= SEQUENCE {
  eventId CHOICE {
    eventA1 SEQUENCE {
      a1-Threshold MeasTriggerQuantity,
      reportOnLeave BOOLEAN,
      hysteresis Hysteresis,
      timeToTrigger TimeToTrigger
    },
    eventA2 SEQUENCE {
      a2-Threshold MeasTriggerQuantity,
      reportOnLeave BOOLEAN,
      hysteresis Hysteresis,
      timeToTrigger TimeToTrigger
    },
    eventA3 SEQUENCE {
      a3-Offset MeasTriggerQuantityOffset,
      reportOnLeave BOOLEAN,
      hysteresis Hysteresis,
      timeToTrigger TimeToTrigger,
      useAllowedCellList BOOLEAN
    },
    eventA4 SEQUENCE {
      a4-Threshold MeasTriggerQuantity,
      reportOnLeave BOOLEAN,
      hysteresis Hysteresis,
      timeToTrigger TimeToTrigger,
      useAllowedCellList BOOLEAN
    },
    eventA5 SEQUENCE {
      a5-Threshold1 MeasTriggerQuantity,
      a5-Threshold2 MeasTriggerQuantity,
      reportOnLeave BOOLEAN,
      hysteresis Hysteresis,
      timeToTrigger TimeToTrigger,
      useAllowedCellList BOOLEAN
    },
    eventA6 SEQUENCE {
      a6-Offset MeasTriggerQuantityOffset,
      reportOnLeave BOOLEAN,
      hysteresis Hysteresis,
      timeToTrigger TimeToTrigger,
      useAllowedCellList BOOLEAN
    },
    ...,
    [[
    eventX1-r17 SEQUENCE {
      x1-Threshold1-Relay-r17 SL-MeasTriggerQuantity-r16,
      x1-Threshold2-r17 MeasTriggerQuantity,
      reportOnLeave-r17 BOOLEAN,
      hysteresis-r17 Hysteresis,
      timeToTrigger-r17 TimeToTrigger,
      useAllowedCellList-r17 BOOLEAN
    },
    eventX2-r17 SEQUENCE {
      x2-Threshold-Relay-r17 SL-MeasTriggerQuantity-r16,
      reportOnLeave-r17 BOOLEAN,
      hysteresis-r17 Hysteresis,
      timeToTrigger-r17 TimeToTrigger
    },
    eventD1-r17 SEQUENCE {
      distanceThreshFromReference1-r17 INTEGER(1.. 65525),
      distanceThreshFromReference2-r17 INTEGER(1.. 65525),
      referenceLocation1-r17 ReferenceLocation-r17,
      referenceLocation2-r17 ReferenceLocation-r17,
      reportOnLeave-r17 BOOLEAN,
      hysteresisLocation-r17 HysteresisLocation-r17,
      timeToTrigger-r17 TimeToTrigger
    }
    ]]
[[
    eventH1 SEQUENCE {
      Event H1 configuration information
}
eventH2 SEQUENCE {
      Event H2 configuration information
}
]]
  },
  rsType NR-RS-Type,
  reportInterval ReportInterval,
  reportAmount ENUMERATED {r1, r2, r4, r8, r16, r32, r64, infinity},
  reportQuantityCell MeasReportQuantity,
  maxReportCells INTEGER (1..maxCellReport),
```

| | |
|---|---|
| reportQuantityRS-Indexes MeasReportQuantity | OPTIONAL, |

-- Need R

| | |
|---|---|
| maxNrofRS-IndexesToReport | INTEGER (1..maxNrofIndexesToReport) |

OPTIONAL, -- Need R
includeBeamMeasurements BOOLEAN,

| | |
|---|---|
| reportAddNeighMeas | ENUMERATED {setup} |

```
OPTIONAL, -- Need R
  ...,
  [[
```

| | |
|---|---|
| measRSSI-ReportConfig-r16 | MeasRSSI-ReportConfig-r16 |

OPTIONAL, -- Need R

| | |
|---|---|
| useT312-r16 BOOLEAN | OPTIONAL, |

-- Need M

| | |
|---|---|
| includeCommonLocationInfo-r16 | ENUMERATED {true} |

OPTIONAL, -- Need R

| | |
|---|---|
| includeBT-Meas-r16 | SetupRelease {BT-NameList-r16} |

OPTIONAL, -- Need M

| | |
|---|---|
| includeWLAN-Meas-r16 | SetupRelease {WLAN-NameList-r16} |

OPTIONAL, -- Need M

| | |
|---|---|
| includeSensor-Meas-r16 | SetupRelease {Sensor-NameList-r16} |

```
OPTIONAL -- Need M
  ]],
  [[
```

| | |
|---|---|
| coarseLocationRequest-r17 | ENUMERATED {true} |

OPTIONAL, -- Need R

| | |
|---|---|
| reportQuantityRelay-r17 | SL-MeasReportQuantity-r16 |

OPTIONAL -- Need R
]]
relatedMeasIdList SEQUENCE (SIZE (1.. maxNrofMeasId)) OF MeasId OPTIONAL, -- Need
R
}

According to an embodiment of the disclosure described above, since there is no need to introduce a new MeasIdToAddModListExt, there may be an advantage in that signaling overhead is relatively small.

According to an embodiment of the disclosure, a plurality of MeasIdToAddMod included in measIdToAddModList of measConfig may indicate the same measId. For example, the plurality of MeasIdToAddMod indicating the same measId may have the same measObjectId. For example, the plurality of MeasIdToAddMod indicating the same measId may have different reportConfigId. In this case, the corresponding measId may have an association relationship with a plurality of reportConfigId indicated by the corresponding plurality of MeasIdToAddMod.

According to an embodiment of the disclosure, a new event may be defined by integrating an altitude-based event and an existing event defined in the NR standard.

For example, when a new event is defined by integrating a plurality of events, the entry conditions of the newly defined event may be configured so that the entry conditions of the integrated events are all satisfied (fulfilled) at the same time. For example, the leaving conditions of a newly defined event may be configured so that all the leaving conditions of integrated events are all satisfied at the same time.

For example, a new event K may be defined by integrating the altitude-based event Hn (n is 1 or 2) and event Ax (x may be one of 1, 2, 3, 4, 5, and 6). For example, the entry condition for the new event K may be defined to include both the entry condition for event Hn and the entry condition for event Ax, so that the entry condition for event K may be satisfied only when both of the entry conditions are satisfied at the same time. For example, the leaving condition of the new Event K may be defined to include both the leaving condition of event Hn and the leaving condition of event Ax, so that the leaving condition of event K may be satisfied only when both of the above leaving conditions are satisfied at the same time.

Through an embodiment of the disclosure described above, a specific measId has an association relationship with one event, but since the corresponding event integrates a plurality of events, the same effect as having an association relationship with the plurality of events can be obtained.

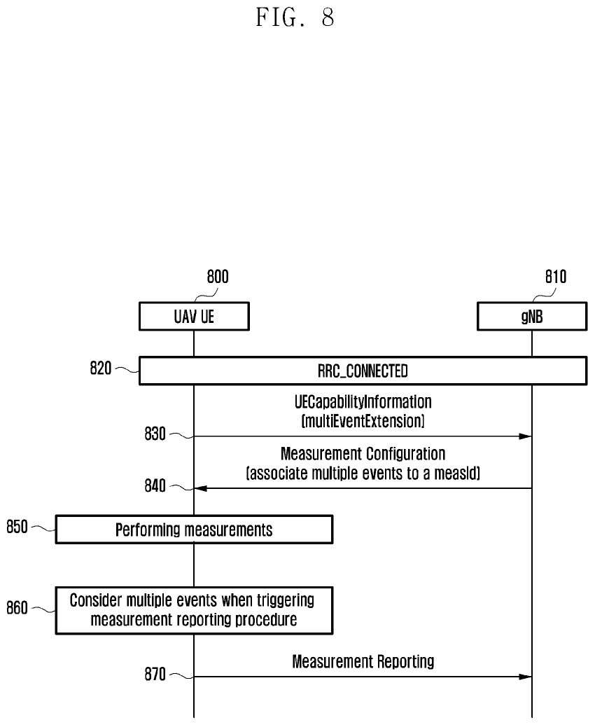

FIG. 8 illustrates an example of a procedure in which a UAV terminal transmits a measurement report to a base station in a next-generation mobile communication system according to an embodiment of the disclosure.

With reference to FIG. 8, in operation 820, a UAV terminal 800 may establish an RRC connection with an NR base station 810 and be in an RRC connected mode (RRC_CONNECTED).

In operation 830, the terminal may transmit a terminal capability information message (UECapabilityInformation) to the base station. The terminal capability information message may include information about whether the terminal supports at least some of the methods provided in an embodiment of the disclosure. For example, the terminal capability information message may include whether to support a configuration function (multiEventExtention) in which one measId and a plurality of events have an association relationship, according to an embodiment of the disclosure.

In operation 840, if the terminal supports a multiEventExtention function, the base station may configure a specific measId to have an association relationship with a plurality of events through measConfig.

In operation 850, the terminal configured through the measConfig may perform a measurement operation. In operation 860, the terminal may trigger a measurement report including a specific measId by considering a plurality of events associated with the corresponding measId. In operation 870, the terminal may perform a measurement report.

The above flowcharts illustrate example methods that can be implemented in accordance with the principles of the disclosure and various changes could be made to the methods illustrated in the flowcharts herein. For example, while illustrated as a series of operations, various operations in each figure could overlap, occur in parallel, occur in a different order, or occur multiple times. In another example, operations may be omitted or replaced by other operations.

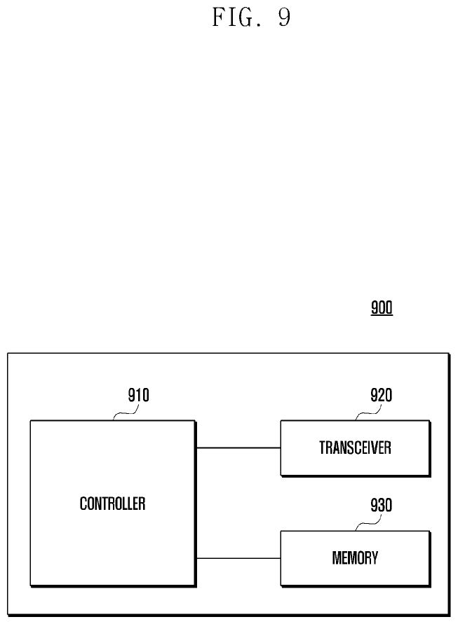

FIG. 9 illustrates a structure of a terminal according to an embodiment of the present disclosure.

With reference to FIG. 9, a terminal 900 may include a transceiver 920, a controller 910, and a memory 930. In the disclosure, the controller may be defined as a circuit, an application-specific integrated circuit, or at least one processor.

The transceiver 920 may transmit and receive signals to and from other network entities. The transceiver 920 may receive, for example, system information from a base station, and may receive a synchronization signal or a reference signal.

The controller 910 may control the overall operation of the terminal 900 according to the embodiment provided in the disclosure. For example, the controller 910 may control the transceiver 920 or memory 930 to perform the operation according to the embodiment described above. Particularly, the controller 910 may control the transceiver 920 to transmit and receive configuration information, control information, or data with the base station according to an embodiment of the disclosure.

The memory 930 may store at least one of information transmitted and received through the transceiver 920 and information generated through the controller 910.

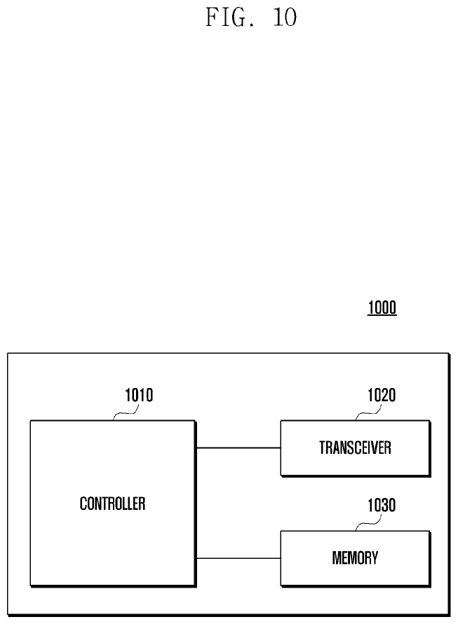

FIG. 10 illustrates a structure of a base station according to an embodiment of the present disclosures.

With reference to FIG. 10, a base station 1000 may include a transceiver 1020, a controller 1010, and a memory 1030. In the disclosure, the controller 1010 may be defined as a circuit, an application-specific integrated circuit, or at least one processor.

The transceiver 1020 may transmit and receive signals to and from other network entities. The transceiver 1020 may transmit, for example, system information to a UE, and may transmit a synchronization signal or a reference signal.

The controller 1010 may control the overall operation of the base station 1000 according to the embodiment provided in the disclosure. For example, the controller 1010 may control the transceiver 1020 or memory 1030 to perform the operation according to the embodiment described above. Particularly, the controller 1010 may control the transceiver 1020 to transmit and receive configuration information, control information, or data with the terminal according to an embodiment of the disclosure.

The memory 1030 may store at least one of information transmitted and received through the transceiver 1020 and information generated through the controller 1010.

Although the figures illustrate different examples of user equipment, various changes may be made to the figures. For example, the user equipment can include any number of each component in any suitable arrangement. In general, the figures do not limit the scope of the disclosure to any particular configuration. Moreover, while figures illustrate operational environments in which various user equipment features disclosed in the patent document can be used, these features can be used in any other suitable system.

Although the disclosure has been described with exemplary embodiments, various changes and modifications may be suggested to one skilled in the art. It is intended that the disclosure encompass such changes and modifications as fall within the scope of the appended claims. None of the description in this application should be read as implying that any particular element, operation, or function is an essential element that must be included in the claims scope. The scope of patented subject matter is defined by the claims.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a communication system, the method comprising:
receiving measurement configuration information including information on a predefined event, wherein the predefined event corresponds to a first event and a second event;
identifying, based on the predefined event, whether an entering condition for the predefined event is satisfied, wherein the entering condition is satisfied in case that both a first entering condition for the first event and a second entering condition for the second event are fulfilled; and
transmitting a measurement report based on the identification.

2. The method of claim 1, wherein the first event is associated with a measurement of a cell and the second event is associated with altitude of the UE.

3. The method of claim 1, wherein the first event is one of an event A3, an event A4, or an event A5, and
wherein the second event is one of an event H1 or an event H2.

4. The method of claim 1, further comprising:
identifying, based on the predefined event, whether a leaving condition for the predefined event, wherein the leaving condition is satisfied in case that both a first leaving condition for the first event and a second leaving condition for the second event are fulfilled.

5. The method of claim 1, wherein the information on the predefined event includes a first set of configuration parameters for the first event and a second set of configuration parameters for the second event.

6. A user equipment (UE) in a communication system, the UE comprising:
a transceiver; and
a processor coupled with the transceiver and configured to:
receive measurement configuration information including information on a predefined event, wherein the predefined event corresponds to a first event and a second event,
identify, based on the predefined event, whether an entering condition for the predefined event is satisfied, wherein the entering condition is satisfied in case that both a first entering condition for the first event and a second entering condition for the second event are fulfilled, and
transmit a measurement report based on the identification.

7. The UE of claim 6, wherein the first event is associated with a measurement of a cell and the second event is associated with altitude of the UE.

8. The UE of claim 6, wherein the first event is one of an event A3, an event A4, or an event A5, and
wherein the second event is one of an event H1 or an event H2.

9. The UE of claim 6, wherein the processor is further configured to identify, based on the predefined event, whether a leaving condition for the predefined event, wherein the leaving condition is satisfied in case that both a first leaving condition for the first event and a second leaving condition for the second event are fulfilled.

10. The UE of claim 6, wherein the information on the predefined event includes a first set of configuration parameters for the first event and a second set of configuration parameters for the second event.

11. A method performed by a base station in a wireless communication system, the method comprising:
transmitting measurement configuration information including a predefined event, wherein the predefined event corresponds to a first event and a second event; and
receiving a measurement report associated with the measurement configuration information,
wherein an entering condition for the predefined event is satisfied in case that both a first entering condition for the first event and a second entering condition for the second event are fulfilled.

12. The method of claim 11, wherein the first event is associated with a measurement of a cell and the second event is associated with altitude of a user equipment (UE).

13. The method of claim 11, wherein the first event is one of an event A3, an event A4, or an event A5, and
wherein the second event is one of an event H1 or an event H2.

14. The method of claim 11, wherein a leaving condition for the predefined event is satisfied in case that both a first leaving condition for the first event and a second leaving condition for the second event are fulfilled.

15. The method of claim 11, wherein the information on the predefined event includes a first set of configuration parameters for the first event and a second set of configuration parameters for the second event.

16. A base station in a wireless communication system, the base station comprising:
a transceiver; and
a processor coupled with the transceiver and configured to:
transmit measurement configuration information including a predefined event, wherein the predefined event corresponds to a first event and a second event, and
receive a measurement report associated with the measurement configuration information,
wherein an entering condition for the predefined event is satisfied in case that both a first entering condition for the first event and a second entering condition for the second event are fulfilled.

17. The base station of claim 16, wherein the first event is associated with a measurement of a cell and the second event is associated with altitude of a user equipment (UE).

18. The base station of claim 16, wherein the first event is one of an event A3, an event A4, or an event A5, and
wherein the second event is one of an event H1 or an event H2.

19. The base station of claim 16, wherein a leaving condition for the predefined event is satisfied in case that both a first leaving condition for the first event and a second leaving condition for the second event are fulfilled.

20. The base station of claim 16, wherein the information on the predefined event includes a first set of configuration parameters for the first event and a second set of configuration parameters for the second event.
